(19) United States
(12) Patent Application Publication
(10) Pub. No.: US 2006/0207707 A1
(43) Pub. Date: Sep. 21, 2006

(54) System comprising a lighter rolling assembly and an ESP device

(75) Inventors: Patrick Cohen, Champs (FR); Stephan Honle, Karntal-Munchingen (DE); Matthew Nimmo, Ludwigsburg (DE); Jacky Pineau, Blanzat (FR)

Correspondence Address: COHEN, PONTANI, LIEBERMAN & PAVANE, Suite 1210, 551 Fifth Avenue, New York, NY, 10176, US

(73) Assignees: Michelin Recherche et Technique S.A., Granges-Paccot (CH); Robert BOSCH GmbH, Gerlingen-Schillerhohe (DE)

(21) Appl. No.: 11/326,147

(22) Filed: Jan. 5, 2006

(30) Foreign Application Priority Data
Jan. 18, 2005 (FR) 05/00497

(51) Int. Cl. B60C 17/04

(52) U.S. Cl. 152/520; 152/158

(57) ABSTRACT

System comprising (1) at least one rolling assembly formed by a rim, a tire and a tire tread support ring, designed to support the tire's load in the event of a substantial pressure loss; and (2) an electronic device for controlling the dynamic behavior of a vehicle equipped with the rolling assembly, wherein the ratio l/L between the respective axial widths l of the support ring and L of the tire tread is smaller than or equal to 0.30.

### FIELD OF THE INVENTION

The present invention concerns rolling assemblies comprising a tire designed for running flat. The invention also concerns electronic devices for controlling the dynamic behavior of a vehicle.

### DEFINITIONS

“Rolling assembly” is understood to mean the assembly formed by a wheel, a tire fitted on the wheel, and in some cases a support ring inside the tire.

“Running flat” or “rolling in extended mode” means the rolling of a tire whose inflation pressure is abnormally low compared with the recommended service pressure of the tire, this inflation pressure possibly even being zero.

### TECHNOLOGICAL BACKGROUND

Tires or systems for passenger cars are known, which can operate at low or zero pressure for the purpose of ensuring or extending the mobility of the vehicle compared with a conventional tire, for example after a puncture. These tires or systems are commonly called “run flat” because they can continue rolling when deflated. One of the concepts that make this performance possible is based on a high rigidity of the sidewalls of the tire, which can then work under radial compression and support the tread. This concept (see for example the U.S. Pat. No. 5,968,294) is known by the names “SST” (Self Supporting Tire) or “ZP” (Zero Pressure). Another concept (see for example the U.S. Pat. No. 6,092,575 and U.S. Pat. No. 6,418,992) uses a support ring placed inside the tire to restrict its deflection. The system proposed commercially under the name “PAX” is an example of the implementation of that concept. This type of solution enables a vehicle, after a tire burst, to cover a large distance, for example 125 miles (200 km), at a limited speed, for example 50 mph (80 km/h), allowing the vehicle user to continue his journey and carry out the repair later, whereas a conventional tire that has burst has to be repaired or replaced at once. Thus, the mobility of the vehicle is greatly extended.

The use of such a system in place of a conventional rolling assembly induces a number of changes at the level of the vehicle's characteristics. In particular, the use of a support ring inside the tire increases the mass of the rolling assembly, which goes against the efforts of automobile manufacturers to reduce the vehicle's mass and especially its rotating masses. Attempts have been made to reduce the dimensions of the ring and so to minimize the added weight, but it is found that there is very little room for maneuver in miniaturizing the support ring: reduction of the height h or width l of the support ring below certain limits induces a deterioration of the vehicle's behavior and decreases its mobility. Thus, to ensure a mobility of the order of 125 miles (200 km) or more at a speed of the order of 50 mph (80 km/h) or more, the ratio l/L (where L is the width of the tire tread) must be above 0.30 and the ratio h/H (where H is the height of the tire) must be above 0.35.

One purpose of the invention is to enable a reduction of the weight of the rolling assembly while still ensuring run-flat mobility and sufficient lateral stability of the vehicle.

This objective is achieved by a system comprising:

(1) at least one rolling assembly formed by a rim, a tire and a tire tread support ring, designed to support the tire's load in the event of a substantial pressure loss;

(2) an electronic device for controlling the dynamic behavior of a vehicle equipped with the rolling assembly,

wherein the ratio l/L between the axial width of the support ring and the axial width L of the tire tread is smaller than or equal to 0.30.

The objective is also achieved by a system comprising:

1) at least one rolling assembly formed by a rim, a tire and a tire tread support ring, designed to support the tire's load in the event of a substantial pressure loss;

(2) an electronic device for controlling the dynamic behavior of a vehicle equipped with the rolling assembly,

wherein the ratio h/H between the radial height h of the support ring and the radial height H of the tire is smaller than or equal to 0.35. These two approaches can advantageously be combined, using a support ring whose size is such that the ratio l/L between the axial width of the support ring and the axial width of the tread is smaller than or equal to 0.30 and the ratio between the radial height h of the support ring and the radial height H of the tire is smaller than or equal to 0.35.

According to a preferred embodiment, the system also comprises means that enable contact between the support ring and the tire to be detected, such that at least one parameter of an algorithm of the control device is modified when contact between the support ring and the tire is detected. Such a control device has been described in WO 2004/101336.

Contact between the support ring and the tire can be detected in very different ways. A mechanical contact sensor can be used, but it is also possible to use a means for measuring the inflation pressure of the tire. In effect, a correspondence can be established between the inflation pressure of the tire and the existence of contact between it and the support ring. Any of the known methods for determining the inflation pressure can, therefore, be used, such as pressure sensors, means for analyzing the rotation speeds of all the vehicle's wheels, means for analyzing the vertical accelerations of all the vehicle's wheels, etc. Finally, other means may be used to detect contact with the support ring; in particular, means for the detection of characteristic vibrations can be used, including characteristic acoustic signals.

This invention will be better understood from the description of the drawings, in which:

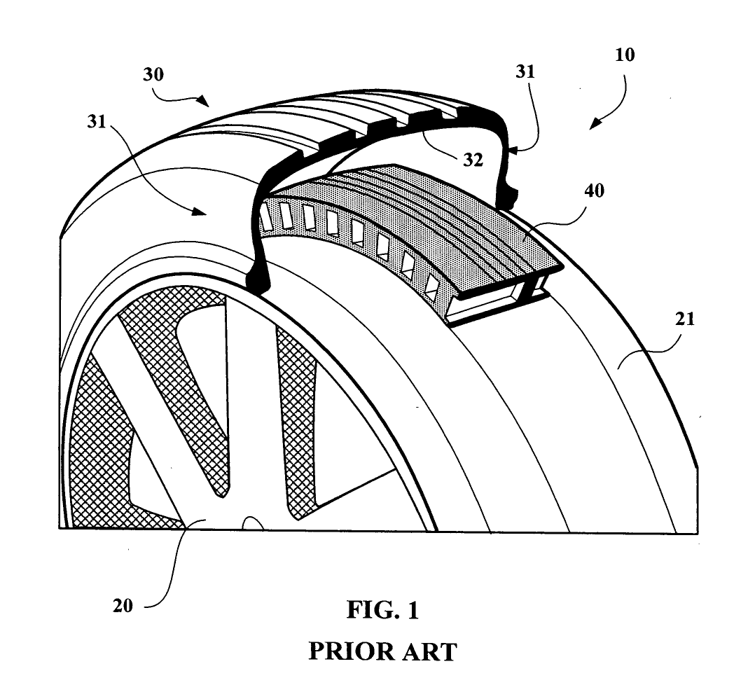

FIG. 1 shows a run-flat rolling assembly, according to the prior art.

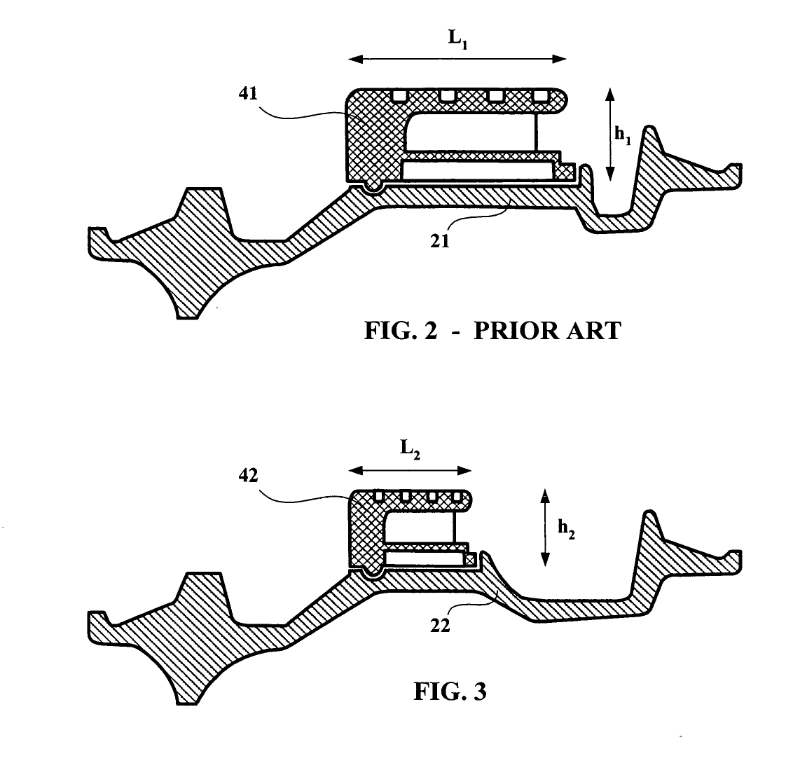

FIG. 2 shows a schematic, meridian section of a rim and a support ring according to the prior art.

FIG. 3 shows a schematic meridian section of a rim and support ring according to the invention.

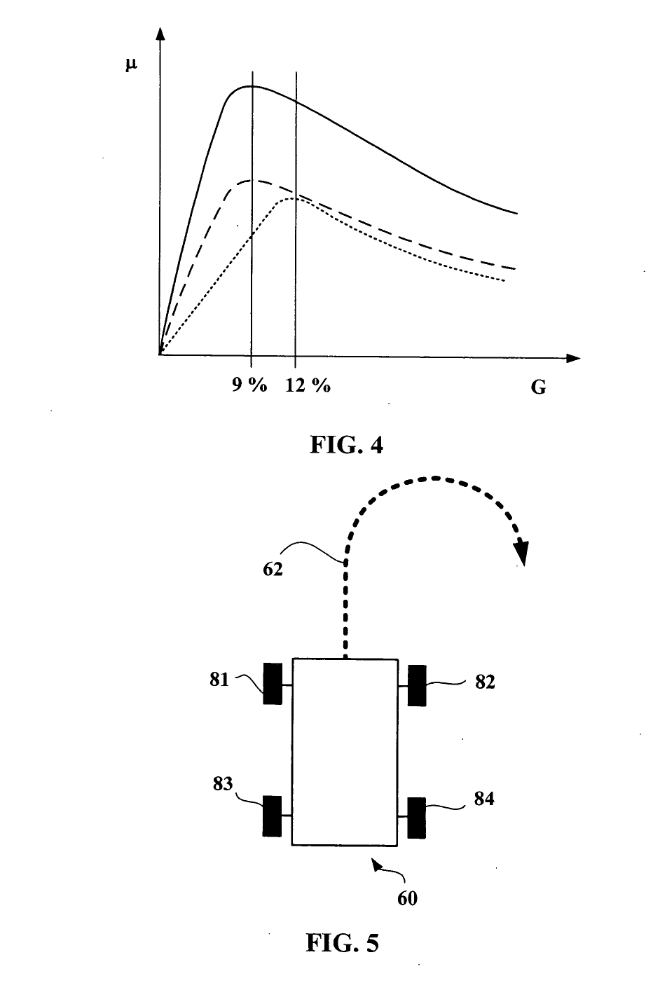

FIG. 4 is a schematic illustration of the law of longitudinal friction μ(G) for various types of rolling assemblies.

FIG. 5 is a schematic illustration of a vehicle about to carry out a maneuver known as a “J turn”.

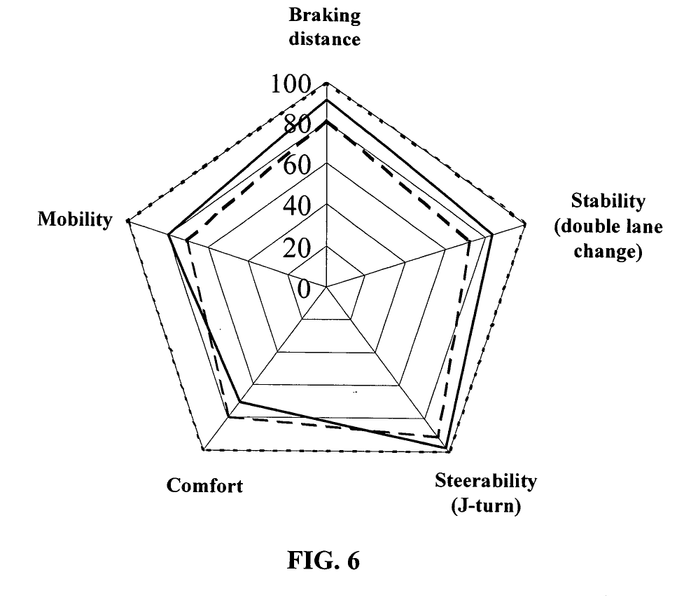

FIG. 6 shows a spider chart diagram summarizing the results of tests.

### DESCRIPTION OF EMBODIMENTS

FIG. 1 is a perspective representation of a partial section of a “run flat” rolling assembly 10 of the “PAX system” type, which comprises a wheel 20 with its rim 21, a tire 30 with sidewalls 31 and a crown 32, and a support ring 40. When the tire deflates, for example after a puncture, the vehicle's weight causes the sidewalls 31 to bend so that, near the contact zone between the tire 30 and the road, the crown 32 comes in contact with the support ring 40.

As shown in FIG. 1, the support ring is not solid but has a complex geometry which is the result of efforts to reduce the weight of the support ring 40 and hence of the rolling assembly 10 as a whole.

FIG. 2 is a schematic meridian section showing certain elements of a “run flat” rolling assembly of the “PAX system” type. A rim 21 and a support ring 41 of the prior art mounted on the said rim can be seen. The tire is not shown. The width L₁ of the support ring 41 is 120 mm and its height h₁ is 40 mm. A rolling assembly fitted with a support ring of this type can retain considerable mobility: after a drop of the tire's inflation pressure, the vehicle fitted with this rolling assembly can still cover a distance of 125 miles (200 km) at a speed of 50 mph (80 km/h).

FIG. 3 is a schematic meridian section showing a rim 22 and a support ring 42 according to the invention mounted on the rim. Again, the tire is not shown. The width L₂ of the ring is 60 mm and its height h₂ is 30 mm; thus, its dimensions are significantly smaller compared with a support ring of the prior art. If such a ring is used in a rolling assembly of a vehicle not fitted with the system according to the invention, the mobility of the rolling assembly and the behavior of the vehicle in extended mode are significantly downgraded.

This difficulty is eliminated by the use of an electronic device for controlling the adapted dynamic behavior, which associates a wheel anti-block unit (ABS) and an anti-skid unit (ASR).

The electronic device for controlling the dynamic behavior according to the invention is known by the acronym ESP (“Electronic Stability Program”). For the sake of brevity, the electronic device for controlling the dynamic behavior will therefore be called the “ESP device”.

The ESP device according to the invention takes advantage of several observations:

Firstly, it has been found that the braking characteristics of a “run flat” rolling assembly, of the “PAX system” type, differ from the characteristics of a traditional or “SST” type rolling assembly. One of the differences is illustrated in FIG. 4, which shows the dependence of the friction coefficient μ on the slip ratio G in the contact area (“μ(G) law”). As is well known to those engaged in the field, G is defined as the ratio between the tire/ground slip speed and the speed of the vehicle:

$$G = \frac{ω \cdot R - V}{V}$$

where ω is the angular speed of the wheel, R is the rolling radius and V is the speed of the vehicle. For V different from zero, the slip ratio G reaches 100% when the wheel is locked (ω=0). FIG. 4 shows the form adopted by the μ(G) law on dry ground for a rolling assembly having a tire inflated to its service pressure (full curve), and for rolling assemblies comprising a tire at zero inflation pressure, of the “SST” type (dashed curve) and of the “PAX system” type (dotted curve). With the “SST”-type tire at zero inflation pressure, the friction coefficient reaches its maximum value at the same slip ratio (about 9%) as with the tire inflated to service pressure. In contrast, with the “PAX system” tire the maximum value of the friction coefficient is reached at a higher slip ratio (about 12%). An ESP device that sought to optimize the braking by maintaining a slip ratio of 9%—this being appropriate for a conventional tire (and for an “SST” tire running flat)—would not fully utilize the friction potential of the “PAX system” tire when running flat. When a vehicle is fitted with tires of that type, it is therefore advantageous to use an ESP device which takes into account the inflation pressure of the tires: during braking, a slip ratio of 9% is aimed at if the tire is inflated to service pressure, and 12% if the tire is flat.

Secondly, the direct consequence of using a narrower support ring is to reduce the resistance with which the tire can oppose lateral forces when it is flat. This tends to reduce the lateral stability of the vehicle and cause its handling and steering to deteriorate. In particular this is the case when the vehicle engages into a yawing movement in which the tire is subjected to lateral force. If it does not resist that lateral force, the vehicle loses its stability and begins to “spin”. In the configuration in which the vehicle is fitted with “PAX system” tires and in which a tire is running flat, the importance of having a large support ring can be measured. The narrower the support ring, the greater is the risk of causing the stability of the vehicle to deteriorate. This is one of the reasons which limited the miniaturization of the support ring and hence the reduction of its weight.

The invention proposes to overcome this obstacle to reducing the weight of the rolling assembly by combining a support ring of reduced width with an ESP device that enables the vehicle's stability and braking capacity to be conserved in a run-flat situation.

The advantage of this approach can be illustrated by considering a maneuver of the “J-turn” type, as represented schematically in FIG. 5. During a maneuver of this type the vehicle 60 follows a path such as that suggested by the arrow 62. The person skilled in the art will understand that the radius of curvature round the curve is generally larger, compared with the dimensions of the vehicle, than indicated in the figure.

Considering the case when the vehicle is fitted with “PAX system” tires and the tire 81 is running flat, the vehicle will tend to understeer. This difficulty is overcome with the aid of an ESP device that enables the tires 83 and 84 to be braked and accordingly the braking force on the tire 81 to be reduced.

A series of tests were carried out to assess the behavior of a system according to the invention under normal rolling conditions (with the tire inflated) and when running flat. The tests were carried out both with a standard ESP device and with an adapted ESP device (“optimized ESP”), to determine the margin of improvement made available by adaptation of the algorithms to the rolling assembly used. The tests were carried out with an Audi A4 vehicle; Table 1 summarizes the dimensions of the rolling assemblies used:

TABLE 1

| | | | Rolling assembly “B” |
|---|---|---|---|
| | | Rolling assembly “A” | (according to the |
| | | (control) | invention) |
| Wheel | | 205x440A | 205x440A |
| Support | Radius (mm) | 440 | 440 |
| ring | Width (mm) | 120 | 60 |
| | Height (mm) | 40 | 40 |

| | | |
|---|---|---|
| Tire | 215-650R440 | 215-650R440 |
| Total mass (kg) | 23.6 | 22.1 |

Table 2 summarizes the results obtained with these two rolling assemblies in braking tests on dry ground (speed before braking: 62 mph (100 km/h); the distance traveled before the vehicle comes to rest is measured) at an ambient temperature of 24° C., and in double lane-change tests in accordance with the standard ISO 3888-1. This second type of test consists in carrying out obstacle-avoidance maneuvers and determining the maximum entry speed at which the required path can be followed. When the tire is deflated, the table shows two values depending on whether the deflated tire (mounted at the rear of the vehicle) is on the inside or outside of the vehicle relative to the centre of the curvature of the path at the beginning of the first lane-change. All the values have been referred to those obtained for the control (“A”) with the standard ESP device and the tire inflated, arbitrarily set at 100.

TABLE 2

| | Inflated tire | Deflated tire | Deflated tire |
|---|---|---|---|
| Rolling assembly | Standard ESP | Standard ESP | Optimized ESP |
| | Braking distance on dry ground | | |
| “A” | 100 | 87 | 92 |
| “B” | 100 | 81 | 92 |
| | Deceleration on dry ground | | |
| “A” | 100 | 89 | 93 |
| “B” | 100 | 84 | 92 |
| | Double lane-change ISO: max. initial speed | | |
| “A” | 100 | 71/70 | 81/81 |
| “B” | 96 | 71/68 | 81/80 |

These results show that compared with a standard PAX system, the system according to the invention behaves in a satisfactory way. It is also apparent that there is some potential for improvement through the use of an adapted ESP device. As regards braking on dry ground, the optimization of the ESP results in a reduction of braking distance and an increase of deceleration amounting to between about 5 and 10%. The results obtained with the optimized ESP are substantially identical for the two different rolling assemblies, whereas the rolling assembly fitted with the support ring of smaller width gives less satisfactory results when the standard ESP is used. Use of the optimized ESP also allows the maximum initial speed to be increased in the double lane-change tests.

Other tests were carried out with the rolling assembly according to the invention (“B”); the results are summarized in Table 3. All the values have been normalized relative to the values obtained with rolling assembly “B” with the tire inflated; the differences between the results of identical tests for rolling assembly “B” that appear in Tables 2 and 3 are to be explained by a difference of the value taken as reference.

TABLE 3

| | | | Rolling |
|---|---|---|---|
| | Rolling | Rolling | assembly |
| | assembly | assembly | “B” |
| | “B” | “B” | Deflated tire |
| | Inflated tire | Deflated tire | Optimized |
| Parameter | Standard ESP | Standard ESP | ESP |
| Braking on dry | 100 | 81 | 91 |
| ground: distance | | | |
| Braking on dry | 100 | 84 | 92 |
| ground: deceleration | | | |
| Double lane-change: | 100 | 74/71 | 84/83 |
| max. initial speed | | | |
| <<J-turn>> stability: | 100 | 91 | 97 |
| max. initial speed | | | |
| Comfort of use | 100 | 80 | 70 |
| (subjective score) | | | |
| Mobility: speed | 100 | 70 | 80 |
| (subjective score) | | | |

In the “J-turn”-type tests, the beneficial effect of optimizing the ESP is significant: the maximum possible initial speed increases from 44 to 47 mph (71 to 76 km/h), very close to the maximum speed (48.5 mph (78 km/h)) possible with an inflated tire.

Table 3 also shows the results of an evaluation of comfort of use and of mobility. This evaluation is subjective: it reflects the driver's feeling during the aforesaid tests at the moment when the ESP device comes into action. The maneuvers are carried out with the deflated tire at the front and then at the rear of the vehicle; the less good of the two scores is retained. The standard ESP device is relatively slow to respond, this being felt as more comfortable provided, of course, that the action is not too harsh. The optimized ESP device acts relatively more promptly and more harshly, which improves safety but slightly reduces the driver's comfort.

Finally, the mobility of the rolling assembly, or more particularly the speed at which the vehicle can travel in extended mode, was evaluated subjectively. Again, the maneuvers were carried out with the deflated tire at the front, and then at the rear of the vehicle; the less good of the two scores was retained. The system with the optimized ESP allows a speed increase of the order of 10%, i.e. of about 6 mph (10 km/h).

FIG. 6 summarizes these results in a spider chart diagram. The dotted and dashed curves correspond respectively to the results obtained with an inflated tire and with a deflated tire and the standard ESP, while the full curve corresponds to the results obtained with a deflated tire and the optimized ESP.

What is claimed is:

1- A system comprising:
(1) at least one rolling assembly formed by a rim, a tire comprising a tread having an axial width L and a tire tread support ring having an axial width l, designed to support the tire's load in the event of a substantial pressure loss;
(2) an electronic device for controlling the dynamic behavior of a vehicle equipped with the rolling assembly,
wherein the ratio l/L between the axial width l of the support ring and the axial width L of the tread is smaller than or equal to 0.30.

2- A system comprising:
(1) at least one rolling assembly formed by a rim, a tire having a radial height H and a tire tread support ring having a radial height h, designed to support the tire's load in the event of a substantial pressure loss;
(2) an electronic device for controlling the dynamic behavior of a vehicle equipped with the rolling assembly,
wherein the ratio h/H between the radial height h of the support ring and the radial height H of the tire is smaller than or equal to 0.35.

3- A system comprising:
(1) at least one rolling assembly formed by a rim, a tire having a radial height H and comprising a tread having an axial width L and a tire tread support ring having an axial width l and a radial height h, designed to support the tire's load in the event of a substantial pressure loss;
(2) an electronic device for controlling the dynamic behavior of a vehicle equipped with the rolling assembly,
wherein the ratio l/L between the axial width l of the support ring and the axial width L of the tread is smaller than or equal to 0.30 and wherein the ratio h/H between the radial height h of the support ring and the radial height H of the tire is smaller than or equal to 0.35.

4- The system of claim 1, 2 or 3, wherein the system comprises means for detecting that the support ring is in contact with the tire, and in that at least one parameter of an algorithm of the control device is modified when contact between the support ring and the tire is detected.

5- The system of claim 4, wherein the means for detecting contact between the support ring and the tire are chosen from among: a mechanical contact sensor, a pressure sensor, means for analyzing the rotation speeds of all the vehicle's wheels, means for analyzing the vertical accelerations of all the vehicle's wheels, a detector of characteristic vibrations, or a detector of characteristic acoustic signals.
